(19) United States
(12) Patent Application Publication
(10) Pub. No.: US 2022/0048578 A1
(43) Pub. Date: Feb. 17, 2022

(54) MUD FLAP REPAIR APPARATUS AND METHOD

(71) Applicant: Doug Brown, Sacramento, CA (US)

(72) Inventor: Leroy Childs, JR., Roseville, CA (US)

(73) Assignee: Doug Brown, Sacramento, CA (US)

(21) Appl. No.: 17/464,352

(22) Filed: Sep. 1, 2021

Related U.S. Application Data
(63) Continuation of application No. PCT/US2020/021263, filed on Mar. 5, 2020.
(60) Provisional application No. 62/919,326, filed on Mar. 8, 2019.

(51) Int. Cl. B62D 25/18

(52) U.S. Cl. CPC B62D 25/188

(57) ABSTRACT

An apparatus and method that can be used to repair a mud flap that has been torn off of the bolt that fastens the mud flap to the hanger bracket on a vehicle. The bolt and torn mud flap are removed from the hanger bracket and the apparatus is positioned over the upper edge of the mud flap where the bolt tore through. The bolt is then inserted through holes in the apparatus and the mud flap, and the assembly is reattached to the hanger bracket.

### CROSS-REFERENCE TO RELATED APPLICATIONS

This application claims priority to, and is a 35 U.S.C. § 111(a) continuation of, PCT international application number PCT/US2020/021263 filed on Mar. 5, 2020, incorporated herein by reference in its entirety, which claims priority to, and the benefit of, U.S. provisional patent application Ser. No. 62/919,326 filed on Mar. 8, 2019, incorporated herein by reference in its entirety. Priority is claimed to each of the foregoing applications.

The above-referenced PCT international application was published as PCT International Publication No. WO 2020/185526 A1 on Sep. 17, 2020, which publication is incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to mud flaps used on a vehicle, and more particularly to a mud flap repair apparatus and method.

### 2. Background Discussion

Many types of vehicles, and particularly trucks, use mud flaps. Typically the mud flap is held in place by a bolt that is attached to a hanger bracket on the vehicle. A common problem is that when the vehicle is backed into a snow bank, curb or other obstruction, the mud flap can get caught by the tire and tear out of the bolt that holds the mud flap to the bracket.

### BRIEF SUMMARY

This disclosure describes an apparatus and method that can be used to repair a mud flap that has been torn off of the bolt that fastens the mud flap to the hanger bracket on a vehicle. The bolt and torn mud flap are removed from the hanger bracket and the apparatus is positioned over the upper edge of the mud flap where the bolt tore through. The bolt is then inserted through holes in the apparatus and the mud flap, and the assembly is reattached to the hanger bracket.

By way of example, and not of limitation, one embodiment of the apparatus comprises first and second spaced apart gripping and reinforcing sections that are joined at a first end and which terminate at an open second end. The spacing between the first and second sections forms an interior space that is configured to receive a torn portion of a mud flap. Each of the sections also includes a plurality of spikes that extend into the interior space and which can have their tips oriented toward the first end of the apparatus where the sections are joined. First and second holes extend through the first and second sections of the apparatus, respectively. The first and second holes are positioned such that, when a mud flap is inserted into the interior space, a bolt or other fastener can extend through the two sections and an existing hole in the torn mud flap for reattaching the mud flap to the hanger bracket. Tightening the bolt compresses the apparatus and presses the spikes into the mud flap. The torn portion of the mud flap is reinforced by the apparatus as a result of the engagement between the mud flap and the plurality of spikes in each section of the apparatus. Orienting the tips of the spikes toward the first end of the apparatus also helps prevent the mud flap from backing out of the apparatus after insertion.

Beneficially the apparatus allows a mud flap to be repaired on the road, as well as allows a mud flap to be repaired when a replacement is not available. Additionally, since damaged mud flaps can be reused, there will be less waste to be disposed of in landfills.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The technology described herein will be more fully understood by reference to the following drawings which are for illustrative purposes only:

FIG. 1 is top plan view of an embodiment of a mud flap repair apparatus prior to being bent into shape where the viewed surface will form the outside of the apparatus.

FIG. 2 is a front view of the apparatus of FIG. 1 after being bent into shape.

FIG. 3 is a side view of the apparatus of FIG. 2.

FIG. 4 is a bottom plan view of a second embodiment of a mud flap repair apparatus prior to being bent into shape where the viewed surface will form the inside of the apparatus.

FIG. 5 a top view of the apparatus of FIG. 4 after being bent into shape.

FIG. 6 is a rear view the apparatus of FIG. 4 after being bent into shape.

FIG. 7 is a side view of the apparatus of FIG. 4 after being bent into shape.

FIG. 8 is a detail view of a spike shown in FIG. 7.

FIG. 9 is a cross-section view of a spike in FIG. 7 taken through lines 9-9 and showing the tip of the spike.

FIG. 10 is an interior view of the rear section of the apparatus shown in FIG. 7.

FIG. 11 is an interior view of the front section of the apparatus shown in FIG. 7.

FIG. 12 is a perspective view of the apparatus shown in FIG. 7 showing the exterior.

FIG. 13 is a perspective view of the apparatus shown in FIG. 7 showing the interior.

FIG. 14 illustrates an embodiment of the apparatus installed on a mud flap shown in phantom.

FIG. 15A through FIG. 15E illustrate a torn portion of a mud flap and an embodiment of a repair process.

### DETAILED DESCRIPTION

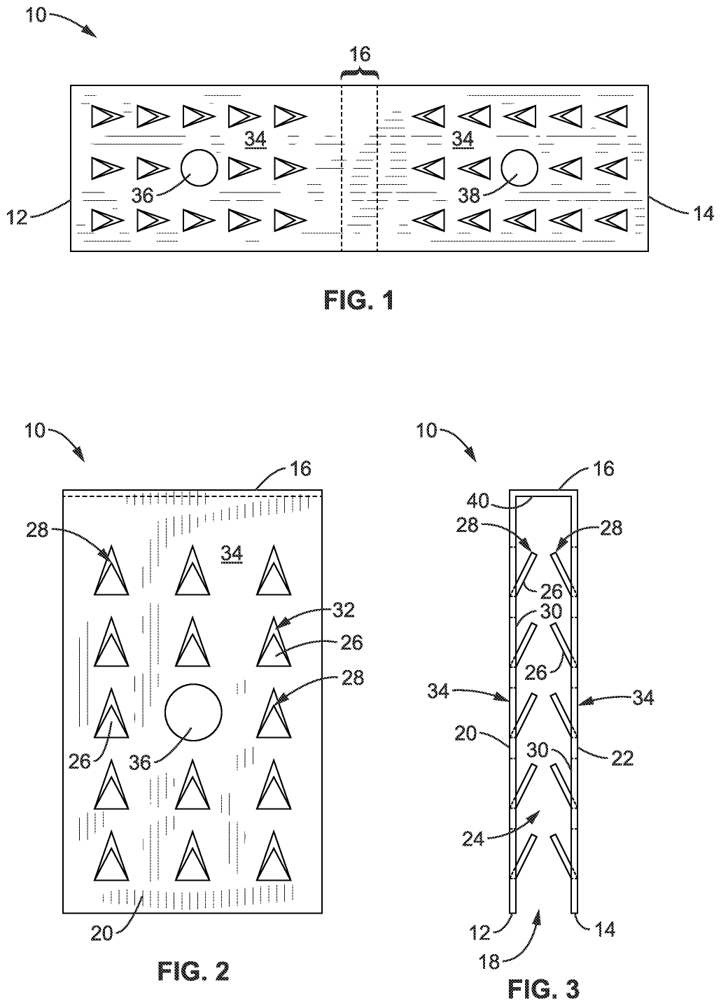

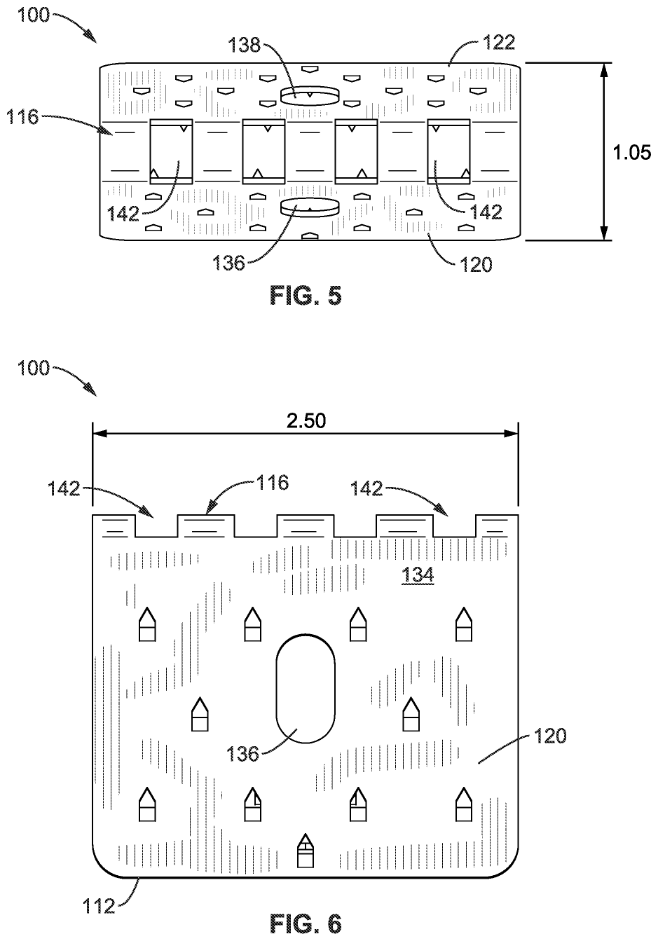

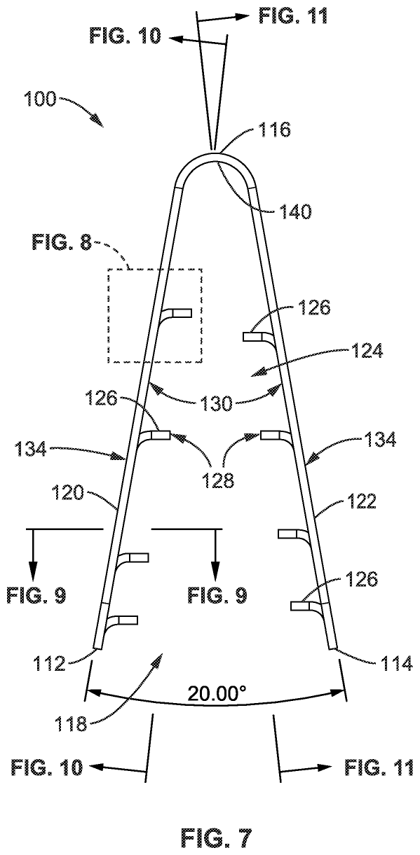

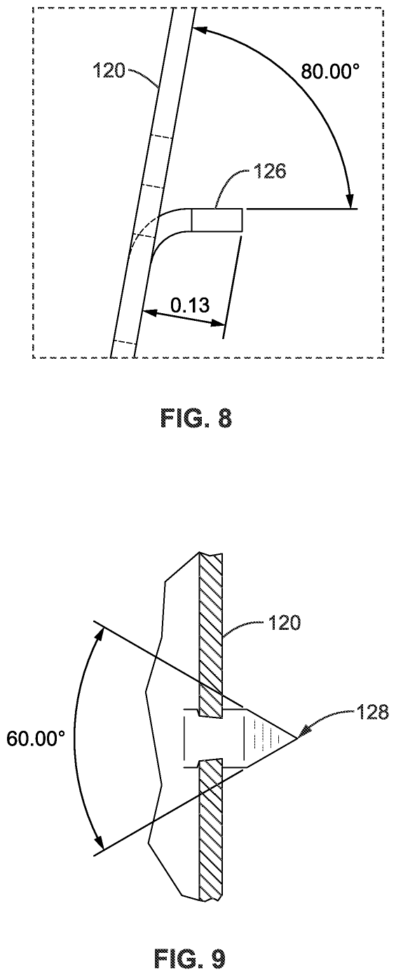

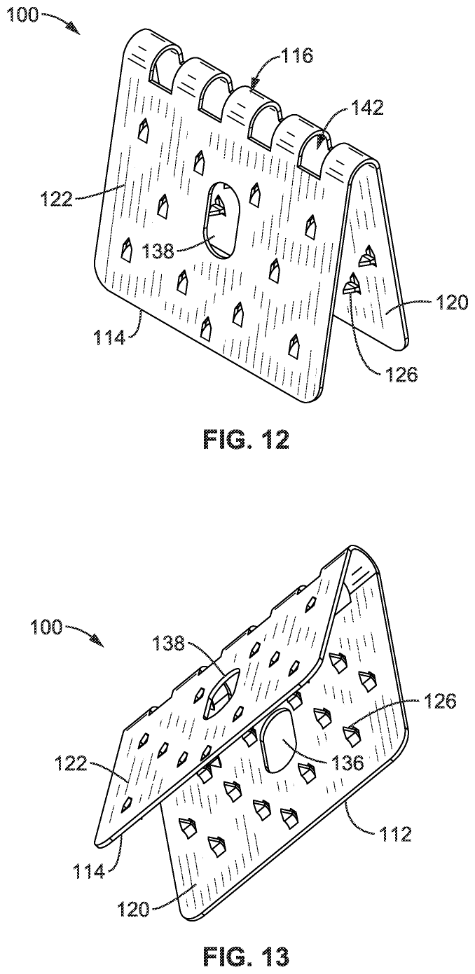

Referring to FIG. 1 through FIG. 15E, various embodiments of a mud flap repair apparatus and method according to the presented technology will be described as non-limiting examples. It will be appreciated that the technology can be embodied in other ways without departing from the scope thereof.

FIG. 1 through FIG. 3 illustrate an embodiment 10 of an apparatus configured for repairing a mud flap according to this disclosure. In this embodiment, the apparatus is illustrated in the form of a structure or a clip that comprises an elongate strip of material having a first end 12, a second end 14, and a bend 16 between the first and second ends. The first and second ends are spaced apart and not joined, thereby defining an opening 18 that is configured for receiving a portion of a mud flap for repair.

The apparatus includes first and second spaced apart gripping and reinforcing sections 20, 22 between the bend 16 and the first and second ends 12, 14, respectively. As can be seen, the gripping and reinforcing sections are joined at the bend but terminate at the open end of the apparatus. The spacing between the first and second gripping/reinforcing sections forms an interior space 24 that extends from the first and second ends 12, 14 to the bend 16 and which is configured to receive a portion of a mud flap for repair.

In the embodiment illustrated the bend 16 has a squared-off shape but the bend can be arcuate or angled or have other shapes that facilitate the formation of the interior space between the gripping/reinforcing sections. Also, this embodiment illustrates an example of gripping/reinforcing sections that have a rectangular shape but the sections can be square, circular, oval or other shapes as well.

Each of the gripping/reinforcing sections also includes a plurality of spikes 26 that extend into the interior space 24 and which have tips 28. The tips are preferably pointed and sharp so that they can pierce the surface of the mud flap and extend into and engage the mud flap.

In the embodiment shown, the apparatus is fabricated from a metal material or the like and the spikes 26 are stamped in the material such that the spikes extend outward from the inner surface 30 of the gripping/reinforcing section with openings 32 remaining between the inner surface 30 and outer surface 34 of the section. It will be appreciated that other ways of forming spikes that extend into the interior space 24 could be used, that the spikes could have different shapes and orientations, and that the quantity and placement of the spikes can vary.

A first hole 36 extends through the first section 20 and a second hole 38 extends through the second section 22. These first and second through-holes are positioned such that they substantially align when the gripping/reinforcing sections are compressed to a substantially parallel position in relation to each other. FIG. 3 illustrates this substantially parallel orientation of the two sections. When a mud flap is inserted through the opening 18 and into the interior space 24, a bolt or other fastener can extend through the first and second through-holes 36, 38 (and the mud flap) for reattaching the mud flap to a hanger bracket other mud flap support mechanism on the vehicle.

The through-holes can be circular-shaped as shown or oval or elongated or other shapes to allow for a degree of placement adjustability between the apparatus, fastener, mud flap and bracket. Preferably the mud flap is inserted sufficiently far into the interior space 24 that the edge of the mud flap abuts the inner surface 40 of the bend 16. Tightening the fastener compresses the gripping/reinforcing sections against the sides of the mud fap and presses the spikes into the mud flap. The torn portion of the mud flap is reinforced by the apparatus as a result of the engagement between the mud flap and the plurality of spikes in each section of the apparatus. The tips 28 of the spikes 26 may be oriented toward the bend 16 to also help prevent the mud flap from backing out of the apparatus after insertion.

It will be appreciated that mud flaps are attached to vehicles that can undergo harsh conditions such as inclement weather and severe vibration. Accordingly the apparatus is preferably fabricated from a material that is sturdy and can resist damage from corrosion, flexing, and other conditions. Examples of materials that can be used include but are not limited to metals, corrosion resistant metals, steel, stainless steel, and synthetic materials.

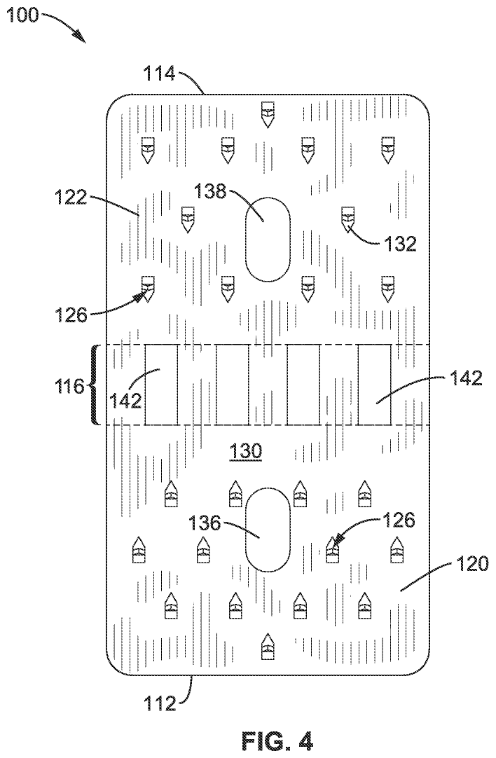

FIG. 4 through FIG. 13 illustrate a second embodiment 100 of the apparatus. This embodiment has a general configuration that is similar to the first embodiment but adds flexibility to the apparatus to prevent metal fatigue. This embodiment also provides for easier insertion of the mud flap into the interior space, and has a more specific spike configuration. The dimensions shown in FIG. 4 through FIG. 13 are provided as non-limiting examples to illustrate the preferred proportions of the apparatus and its features. It will be appreciated that the dimensions and details shown in the figures can vary without departing from the scope of the presented technology.

As with the previously described embodiment, this embodiment of the apparatus is illustrated in the form of an elongate strip of material (FIG. 4) that is bent into the form of a structure or clip having a first end 112, a second end 114, and a bend 116 between the first and second ends. The first and second ends are spaced apart and not joined, thereby defining an opening 118 that is configured for receiving a portion of a mud flap for repair.

The apparatus includes first and second spaced apart gripping and reinforcing sections 120, 122 between the bend and the first and second ends 112, 114, respectively. As can be seen, the gripping and reinforcing sections are joined at the bend but terminate at the open end of the apparatus. The spacing between the first and second gripping/reinforcing sections forms an interior space 124 that extends from the first and second ends 112, 114 to the bend 116 and which is configured to receive a portion of a mud flap for repair.

In the embodiment illustrated the bend 116 has an arcuate shape but the bend can have a squared-off, angled or other shape that facilitates the formation of the interior space between the gripping/reinforcing sections. Also, this embodiment illustrates an example of gripping/reinforcing sections that have a rectangular shape but the sections can be square, circular, oval or other shapes as well.

Each of the gripping/reinforcing sections also includes a plurality of spikes 126 that extend into the interior space 124 and which have tips 128 that are preferably pointed and sharp so that they can pierce the surface of the mud flap and extend into and engage the mud flap. FIG. 9 illustrates that in this embodiment the tips come to a point with a 60 degree angle. Tips 128 may also be oriented toward the bend 116 similar to the embodiment shown in FIG. 1 through FIG. 3.

In the embodiment shown, the apparatus is fabricated from a metal material or the like and the spikes 126 are stamped in the material such that the spikes extend outward from the inner surface 130 of the gripping/reinforcing section with openings 132 remaining between the inner surface 130 and outer surface 134 of the section. It will be appreciated that other ways of forming spikes that extend into the interior space 124 could be used, that the spikes could have different shapes and orientations, and that the quantity and placement of the spikes can vary.

A first hole 136 extends through the first section 120 and a second hole 138 extends through the second section 122. These first and second through-holes are positioned such that they substantially align when the gripping/reinforcing sections are compressed to a substantially parallel position in relation to each other. When a mud flap is inserted through the opening 118 and into the interior space 124, a bolt or other fastener can extend through the first and second through-holes 136, 138 (and the mud flap) for reattaching the mud flap to a hanger bracket other mud flap support mechanism on the vehicle.

The through-holes can be oval or elongated as shown to allow for a degree of placement adjustability between the apparatus, fastener, mud flap and bracket. Other shapes can be used as well. Preferably the mud flap is inserted sufficiently far into the interior space 124 that the edge of the mud flap abuts the inner surface 140 of the bend 116. Tightening the fastener compresses the gripping/reinforcing sections against the sides of the mud fap and presses the spikes into the mud flap. The torn portion of the mud flap is reinforced by the apparatus as a result of the engagement between the mud flap and the plurality of spikes in each section of the apparatus.

It will be appreciated that mud flaps are attached to vehicles that can undergo harsh conditions such as inclement weather and severe vibration. Accordingly the apparatus is preferably fabricated from a material that is sturdy and can resist damage from corrosion, flexing, and other conditions. Examples of materials that can be used include but are not limited to metals, corrosion resistant metals, steel, stainless steel, and synthetic materials. Additionally, the apparatus may include a plurality of cutouts or notches 142 in bend 116. In this embodiment four cutouts 142 are shown but there may be fewer or more cutouts provided that strength and flexibility of bend 116 are maintained.

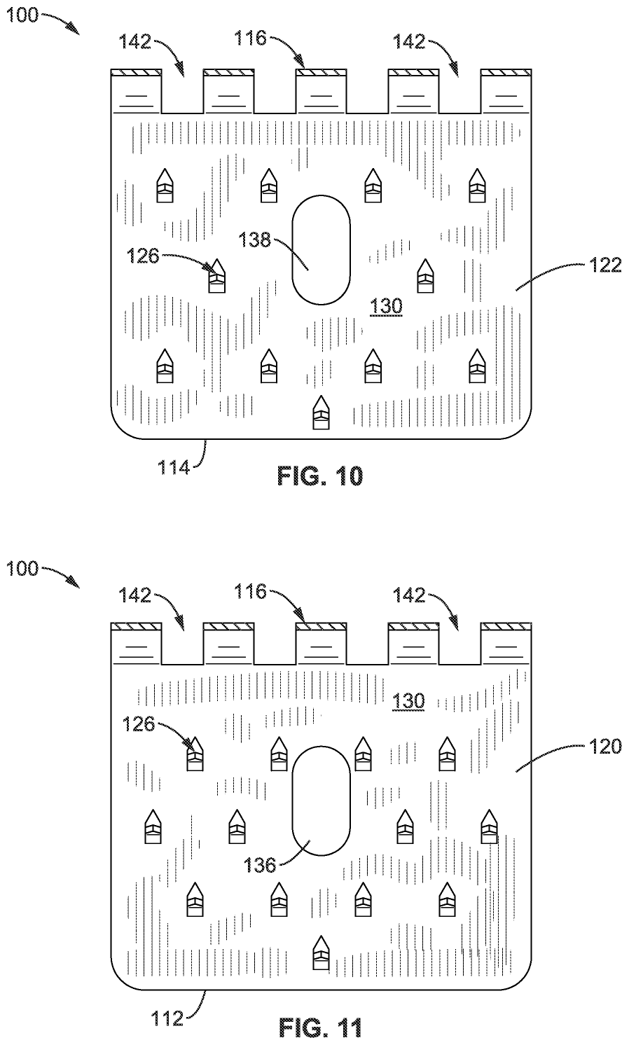

Referring more particularly to FIG. 4, FIG. 10 and FIG. 11, it can be seen that spikes 126 in section 120 have a different pattern than those in section 122. Using different patterns can ensure that the spikes are not opposing each other when the sections are compressed and the spikes are embedded in the mud flap. This configuration prevents the spikes from interfering with each other and provides a more rigid engagement of the mud flap for added repair strength. It will be appreciated that the patterns shown are by way of example and that other patterns can be used.

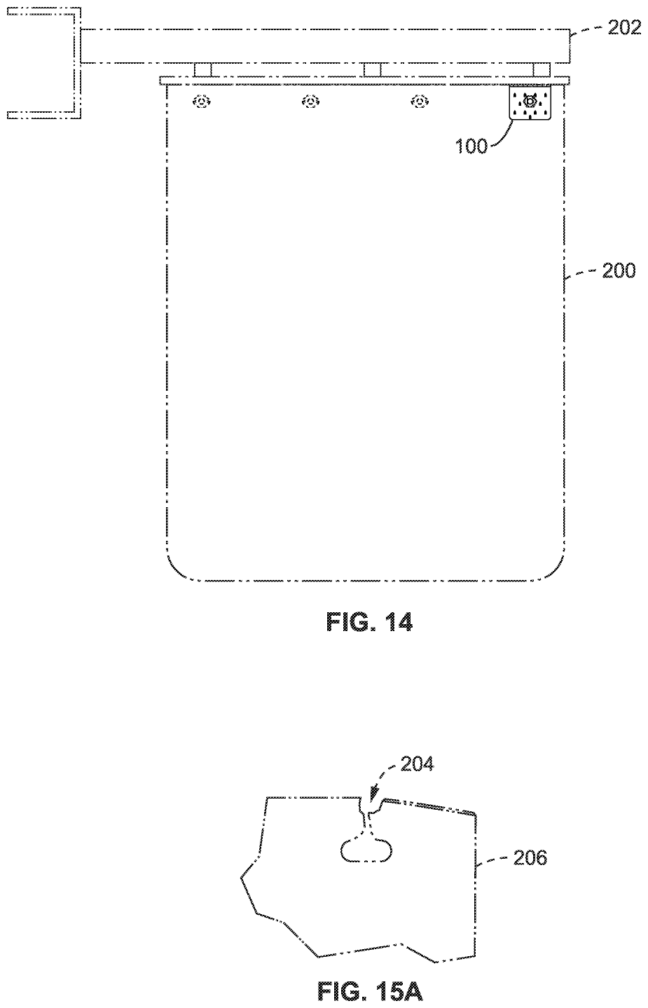

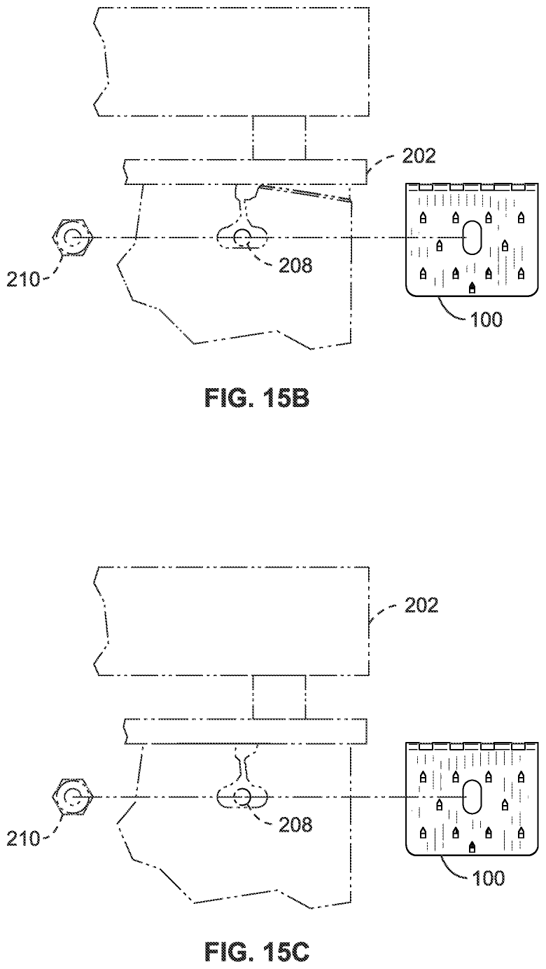

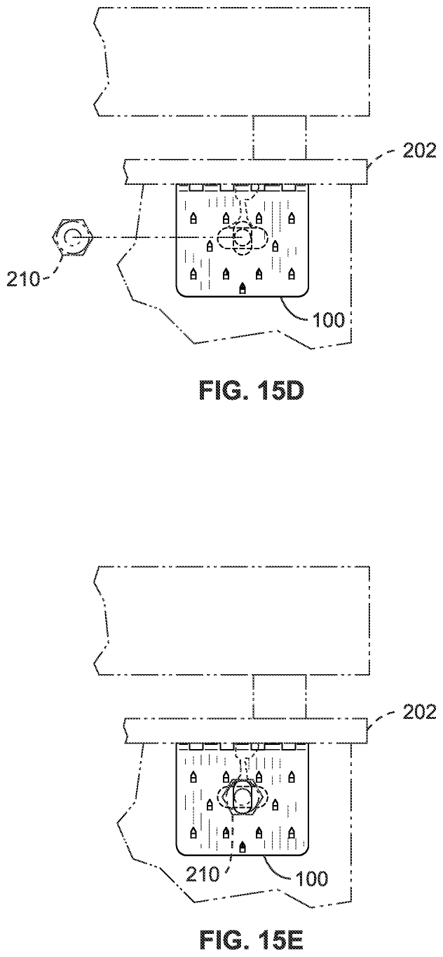

FIG. 14 shows the apparatus 100 installed on a mud flap 200 and the mud flap reattached to the hanger bracket 202 on the vehicle. As can be seen with further reference to FIG. 15A through FIG. 15E, the apparatus is installed at the upper edge of the portion of the mud flap that had torn off of the fastener (e.g., bolt) holding the mud flap on the hanger bracket.

FIG. 15A illustrates an example of a tear 204 in a portion 206 of the mud flap 200 prior to repair. FIG. 15B through FIG. 15E illustrate how the apparatus can be placed on the torn portion of the mud flap and the mud flap reattached. In this example the fastener comprises a bolt 208 and nut 210. As illustrated in FIG. 15B and FIG. 15C, the mud flap tore off of the outer (rightmost) bolt 208 and the apparatus is shown as being slid laterally over the torn portion. Alternatively, or in the case of an interiorly positioned fastener, the mud flap would be removed and the apparatus placed over the upper edge of the mud flap. FIG. 15D illustrates the apparatus in position for the nut to be threaded onto the bolt and FIG. 15E illustrates the finished configuration after the nut and bolt have been tightened.

Note also that the apparatus can be provided as a component of a repair kit that includes at least one apparatus, at least one fastener (e.g., nut and bolt) and optionally one or more washers such as flat washers, lock washers and spring washers.

From the description herein, it will be appreciated that the present disclosure encompasses multiple embodiments which include, but are not limited to, the following:

1. An apparatus for repairing a mud flap of the type used on a vehicle, the apparatus comprising: (a) an elongate strip of material having a first end, a second end, and a bend between said first and second ends; (b) wherein said first and second ends are spaced-apart and not joined; (c) a first gripping and reinforcing section between said first end and said bend; (d) a second gripping and reinforcing section between said second end and said bend; (e) an interior space between said first and second sections that extends from said first and second ends to said bend; (f) each said section having a plurality of spikes extending into the interior space; (g) a first through-hole in said first section; and (h) a second through-hole in said second section; (i) wherein said interior space is configured to receive a portion of a mud flap; and (j) wherein said portion of said mud flap is gripped and reinforced when a fastener is inserted through said first through-hole, through said portion of said mud flap, and through said second through-hole, and said mud flap is attached to a vehicle with said fastener such that said first and second sections are compressed against said portion of said mud flap.

2. The apparatus of any preceding or following embodiment, wherein said spikes have tips that are oriented toward said bend.

3. The apparatus of any preceding or following embodiment, wherein said first and second through-holes substantially align when said first and second sections are compressed to a substantially parallel position in relation to each other.

4. The apparatus of any preceding or following embodiment, wherein said material comprises a material selected from the group of materials consisting of corrosion resistant materials, metal materials, steel, stainless steel, and synthetic materials.

5. The apparatus of any preceding or following embodiment, wherein said bend includes one or more cutouts.

6. The apparatus of any preceding or following embodiment, wherein said one or more cutouts are configured to allow said first and second sections to flex at said bend.

7. An apparatus for repairing a mud flap of the type used on a vehicle, the apparatus comprising: (a) a structure having first and second spaced-apart sections with an interior space therebetween; (b) said first and second sections configured to grip and reinforce a portion of a mud flap; (c) said first and second sections joined at a first end; (d) said first and second sections extending from said first end to an open second end; (e) each said section having a plurality of spikes extending into the interior space; (f) a first opening in said first section; and (g) a second opening in said second section; (h) wherein said interior space is configured to receive a portion of a mud flap; and (i) wherein said portion of said mud flap is gripped and reinforced when a fastener is inserted through said first opening, through said portion of said mud flap, and through said second opening, and said mud flap is attached to a vehicle with said fastener such that said first and second sections are compressed against said portion of said mud flap.

8. The apparatus of any preceding or following embodiment, wherein said spikes have tips that are oriented toward said first end.

9. The apparatus of any preceding or following embodiment, wherein said first and second openings substantially align when said first and second sections are compressed to a substantially parallel position in relation to each other.

10. The apparatus of any preceding or following embodiment, wherein said structure comprises a material selected from the group of materials consisting of corrosion resistant materials, metal materials, steel, stainless steel, and synthetic materials.

11. The apparatus of any preceding or following embodiment, wherein said first end comprises a bend in said structure, said bend including one or more cutouts.

12. The apparatus of any preceding or following embodiment, wherein said one or more cutouts are configured to allow said first and second sections to flex at said bend.

13. An apparatus for repairing a mud flap of the type used on a vehicle, the apparatus comprising: (a) a clip having spaced apart ends and a bend between said ends; (b) first and second gripping and reinforcing sections between said ends and said bend; (c) an interior space between said sections that extends from said ends to said bend; (d) each said section having a plurality of spikes extending into the interior space; and (e) a hole in each of said first and second sections through which a fastener can extend; (f) wherein said interior space is configured to receive a portion of a mud flap, wherein said portion of said mud flap is gripped and reinforced when a fastener extends through said holes and said portion of said mud flap, said mud flap is attached to a vehicle with said fastener, and said first and second sections are compressed against said portion of said mud flap.

14. The apparatus of any preceding or following embodiment, wherein said spikes have tips that are oriented toward said bend.

15. The apparatus of any preceding or following embodiment, wherein said holes in said first and second sections substantially align when said first and second sections are compressed to a substantially parallel position in relation to each other.

16. The apparatus of any preceding or following embodiment, wherein said clip comprises a material selected from the group of materials consisting of corrosion resistant materials, metal materials, steel, stainless steel, and synthetic materials.

17. The apparatus of any preceding or following embodiment, wherein said bend includes one or more cutouts.

18. The apparatus of any preceding or following embodiment, wherein said one or more cutouts are configured to allow said first and second sections to flex at said bend.

19. A method for repairing a mud flap that has torn off of a fastener holding the mud flap to a vehicle, the method comprising: (a) removing the mud flap from the vehicle; (b) positioning a repair apparatus over an upper edge of a portion of the mud flap that has torn off of the fastener; and (c) inserting a fastener through the repair apparatus and mud flap and reattaching the mud flap to the vehicle; (d) wherein the repair apparatus comprises the apparatus of any of the preceding embodiments.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the term “set” refers to a collection of one or more objects. Thus, for example, a set of objects can include a single object or multiple objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. An apparatus for repairing a mud flap of the type used on a vehicle, the apparatus comprising:
(a) an elongate strip of material having a first end, a second end, and a bend between said first and second ends;
(b) wherein said first and second ends are spaced-apart and not joined;
(c) a first gripping and reinforcing section between said first end and said bend;
(d) a second gripping and reinforcing section between said second end and said bend;
(e) an interior space between said first and second sections that extends from said first and second ends to said bend;
(f) each said section having a plurality of spikes extending into the interior space;
(g) a first through-hole in said first section; and
(h) a second through-hole in said second section;
(i) wherein said interior space is configured to receive a portion of a mud flap; and
(j) wherein said portion of said mud flap is gripped and reinforced when a fastener is inserted through said first through-hole, through said portion of said mud flap, and through said second through-hole, and said mud flap is attached to a vehicle with said fastener such that said first and second sections are compressed against said portion of said mud flap.

2. The apparatus of claim 1, wherein said spikes have tips that are oriented toward said bend.

3. The apparatus of claim 1, wherein said first and second through-holes substantially align when said first and second sections are compressed to a substantially parallel position in relation to each other.

4. The apparatus of claim 1, wherein said material comprises a material selected from the group of materials consisting of corrosion resistant materials, metal materials, steel, stainless steel, and synthetic materials.

5. The apparatus of claim 1, wherein said bend includes one or more cutouts.

6. The apparatus of claim 5, wherein said one or more cutouts are configured to allow said first and second sections to flex at said bend.

7. An apparatus for repairing a mud flap of the type used on a vehicle, the apparatus comprising:
(a) a structure having first and second spaced-apart sections with an interior space therebetween;
(b) said first and second sections configured to grip and reinforce a portion of a mud flap;
(c) said first and second sections joined at a first end;
(d) said first and second sections extending from said first end to an open second end;
(e) each said section having a plurality of spikes extending into the interior space;
(f) a first opening in said first section; and
(g) a second opening in said second section;
(h) wherein said interior space is configured to receive a portion of a mud flap; and
(i) wherein said portion of said mud flap is gripped and reinforced when a fastener is inserted through said first opening, through said portion of said mud flap, and through said second opening, and said mud flap is attached to a vehicle with said fastener such that said first and second sections are compressed against said portion of said mud flap.

8. The apparatus of claim 7, wherein said spikes have tips that are oriented toward said first end.

9. The apparatus of claim 7, wherein said first and second openings substantially align when said first and second sections are compressed to a substantially parallel position in relation to each other.

10. The apparatus of claim 7, wherein said structure comprises a material selected from the group of materials consisting of corrosion resistant materials, metal materials, steel, stainless steel, and synthetic materials.

11. The apparatus of claim 7, wherein said first end comprises a bend in said structure, said bend including one or more cutouts.

12. The apparatus of claim 11, wherein said one or more cutouts are configured to allow said first and second sections to flex at said bend.

13. An apparatus for repairing a mud flap of the type used on a vehicle, the apparatus comprising:
(a) a clip having spaced apart ends and a bend between said ends;
(b) first and second gripping and reinforcing sections between said ends and said bend;
(c) an interior space between said sections that extends from said ends to said bend;
(d) each said section having a plurality of spikes extending into the interior space; and
(e) a hole in each of said first and second sections through which a fastener can extend;
(f) wherein said interior space is configured to receive a portion of a mud flap, wherein said portion of said mud flap is gripped and reinforced when a fastener extends through said holes and said portion of said mud flap, said mud flap is attached to a vehicle with said fastener, and said first and second sections are compressed against said portion of said mud flap.

14. The apparatus of claim 13, wherein said spikes have tips that are oriented toward said bend.

15. The apparatus of claim 13, wherein said holes in said first and second sections substantially align when said first and second sections are compressed to a substantially parallel position in relation to each other.

16. The apparatus of claim 13, wherein said clip comprises a material selected from the group of materials consisting of corrosion resistant materials, metal materials, steel, stainless steel, and synthetic materials.

17. The apparatus of claim 13, wherein said bend includes one or more cutouts.

18. The apparatus of claim 17, wherein said one or more cutouts are configured to allow said first and second sections to flex at said bend.
